(19) United States
(12) Patent Application Publication
(10) Pub. No.: US 2011/0173060 A1
(43) Pub. Date: Jul. 14, 2011

(54) Guest Check Presenter Having a Wireless Communication Device

(76) Inventor: Kevin N. Gallagher, Greenwich, CT (US)

(21) Appl. No.: 12/987,547

(22) Filed: Jan. 10, 2011

Related U.S. Application Data
(60) Provisional application No. 61/293,461, filed on Jan. 8, 2010.

(51) Int. Cl. G06Q 50/00; G06Q 30/00; G06Q 20/00

(52) U.S. Cl. 705/14.27; 705/15

(57) ABSTRACT

A guest check presenter for a food establishment is provided. The guest check presenter includes a holder for holding a guest check information and a wireless communication device attached to the holder and adapted to communicate with a wireless mobile device of the guest. The wireless communication device contains a guest check identifier that identifies the guest check. The guest check identifier is adapted to be retrieved by the wireless mobile device of the guest for use in providing various useful mobile services that are associated with the food establishment or the food consumed by the guest. Thus, the check presenter is used as a platform for providing such mobile services as mobile payment of the guest check and loyalty coupons.

### CROSS REFERENCE TO RELATED APPLICATIONS

This application claims priority under 35 U.S.C. Section 119(e) to U.S. Provisional Application Ser. No. 61/293,461, filed Jan. 8, 2010, which is incorporated herein by reference.

### FIELD OF THE INVENTION

The present invention relates to a guest check presenter having a wireless communication device for use in food establishments. More particularly, the present invention relates to a guest check presenter having a wireless communication device which is adapted to communicate with a guest's wireless mobile device to provide various mobile services associated with the food establishment or the food consumed by the guest.

### BACKGROUND OF THE INVENTION

It is well known that food establishments such as restaurants, bars, diners, coffee shops and the like present a guest check at the end of a meal in a foldable billfold or check presenter that encloses the guest check and includes pockets for receiving the payment. Such check presenters are favored because they are discrete, and can also serve as a notice to the customer that the server will collect the payment at the table. This behavior is common and despite past and future advances in technology, restaurant customers will continue to expect and favor the familiar actions involving the delivery of the check presenter at the end of a meal.

Check presenters are traditionally comprised of leather or plastic cover that encloses a stiff side, such as might be constructed of cardboard or the like. The covers form two complimentary halves that are connected at a spine and fold together in a book-like arrangement. A pocket that is shaped and sized to receive a portion of a standard size financial instrument such as a credit card is often provided that permits the credit card to ride inside safely without falling outside of the check presenter. Sleeves or pockets may also be included to enclose the guest check and retain currency should this traditional form of payment be selected.

However, such a conventional check presenter is used only for receiving payment from the guest and is not capable of offering various mobile services associated with the food establishment or the meal consumed by the guest through a wireless mobile device of the guest. Mobile services are services that are offered through a wireless mobile device carried by the guest. Such services may include mobile payment, targeted advertising, loyalty coupons and nutrition information on the meal, alerting a valet parking attendant for retrieving the guest's car and alerting a coat check attendant, to list a few examples. These mobile services are very convenient and useful to the guest.

Take, for example, the mobile payment service. For payment by credit card or by cash requiring change, a conventional check presenter requires the guest to wait for the waiter to pick up the check presenter. While the guest may be in a hurry to leave, the waiter may be busy serving other guests especially at busy times of the day. Moreover, once the waiter picks up the check presenter, it would have to be brought to the restaurant's cash register to process the payment. Thereafter, the card or change, whichever may be the case, would have to be returned to the guest, which further adds considerable time to pay for the meal.

Therefore, it would be desirable to provide an improved guest check presenter which can be used as a platform to offer various useful and value added mobile services, such as the mobile payment service and advertising, which are associated with the food establishment or the meal consumed by the guest through the wireless mobile device of the guest.

### SUMMARY OF THE DISCLOSURE

According to one aspect of the present invention, a guest check presenter for a food establishment is provided. The guest check presenter includes a holder for holding a guest check and a wireless communication device attached to the holder and adapted to communicate with a wireless mobile device of the guest. The wireless communication device contains a guest check identifier that identifies the guest check. The guest check identifier is adapted to be retrieved by the wireless mobile device of the guest for use in facilitating various mobile services associated with the food establishment or the food consumed by the guest.

According to another aspect of the present invention, a guest check presenter for a food establishment for facilitating payment of the guest check through the guest's mobile device is provided. The guest check presenter includes a holder for holding a guest check information and a wireless communication device attached to the holder and adapted to communicate with a wireless mobile device of the guest. The wireless communication device attached to the holder stores payment facilitating information for facilitating a payment for the guest check by the wireless mobile device of the guest.

Advantageously, the present guest check presenter provides a convenient and powerful way to interface with the guest's mobile device to provide various mobile services that are associated with the food establishment or the meal consumed without the need for the guest to leave the table and without the need to wait for the waiter to pick up the guest check presenter.

### BRIEF DESCRIPTION OF THE DRAWINGS

FIGS. 1A and 1B illustrate a guest check presenter having a wireless communication device.

FIG. 2 illustrates an exemplary system for using the present guest check presenter as a platform for offering various mobile services that are associated with the food establishment or the meal consumed by the guest.

FIG. 3 is a functional block diagram of a computer that can be used by any device or system shown in FIG. 2.

FIG. 4 is a process flow diagram of interactions among the various computers and wireless devices to pay for the guest check with the wireless mobile device of the guest.

FIG. 5 is an alternate process flow diagram of interactions among the various computers and wireless devices to pay for the guest check with the wireless mobile device of the guest.

FIG. 6 is another alternate process flow diagram of interactions among the various computers and wireless devices to pay for the guest check with the wireless mobile device of the guest.

FIG. 7 is a process flow diagram of interactions among the various computers and wireless devices to collect and deliver nutritional/caloric information for the meal just consumed by the guest.

FIG. 8 is a process flow diagram of interactions among the various computers and wireless devices to collect and deliver loyalty coupon information to the wireless mobile device of the guest.

FIG. 9 is a process flow diagram of interactions among the various computers and wireless devices to collect and deliver local advertising information to the wireless mobile device of the guest.

### DETAILED DESCRIPTION OF THE INVENTION

For purposes of this application, the terms “code”, “program”, “application”, “software code”, “software module”, “module” and “software program” are used interchangeably to mean software instructions that are executable by a processor. Also, the phrase “food establishment” means any establishment that serves any substance that can be eaten or drunk such as restaurants, diners, bars, coffee shops or the like.

Briefly, a guest check presenter of the present invention contains a wireless communication device such as an RF ID tag or an NFC tag that holds information such as a guest check identifier for uniquely identifying the guest check. The check presenter is used as a platform to deliver new mobile services to a guest through the guest's mobile device such as a smart phone. The guest check presenter is traditionally recognized as a familiar vessel for delivering a paper guest check to the table at the conclusion of a meal and this customary behavior will continue. However, the guest check presenter of the present invention not only functions to hold a paper check to work as a traditional check presenter but also functions to interface with the guest's mobile device to offer a range of new mobile services including mobile payment and delivering an electronic guest check, loyalty coupons, nutritional/caloric information, and local advertising to name just a few.

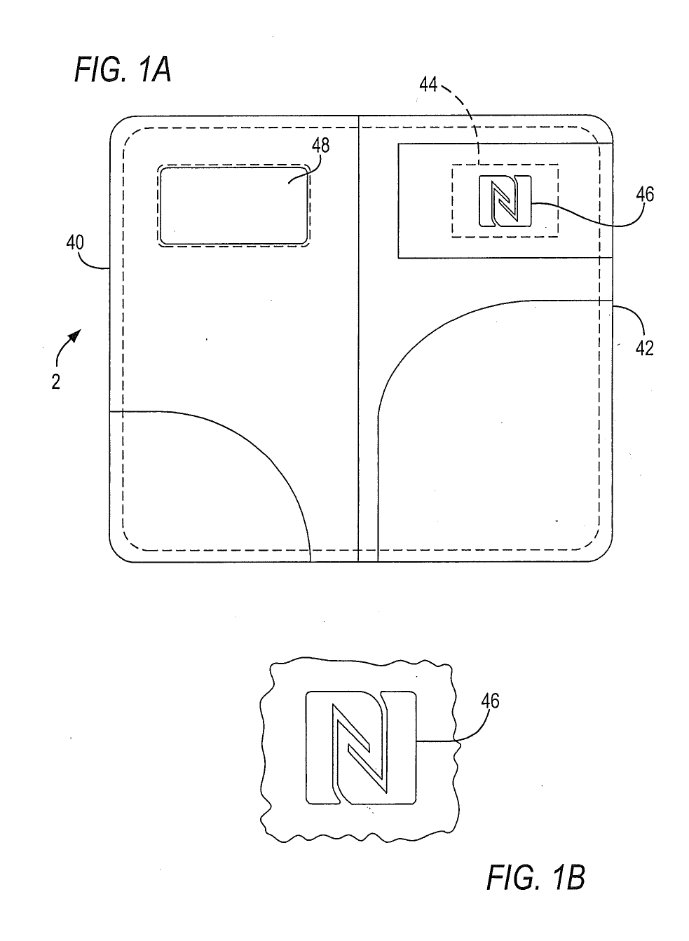

As shown in FIGS. 1A and 1B, a check presenter 2 includes a holder having a top cover 40 and a bottom cover 42 which can be folded together. A wireless communication device 44 is attached to and placed inside the bottom cover 42. The wireless communication device 44 can be any device such as a NFC (Near Field Communication) tag, RF ID (Radio Frequency Identification) tag, blue tooth chip or the like that can wirelessly communicate with a wireless mobile device of a guest.

In the embodiment shown in FIG. 1, an NFC tag/chip technology is used. The NFC tag operates in the 13.56 MHz frequency range, over only short distances of a few centimeters. NFC is already compatible with hundreds of millions of contactless cards and readers and is therefore a safe and inclusive choice.

The physical dimensions of the NFC tag itself will vary by supplier and in FIG. 1, it is placed inside the check presenter 2 and under the skin of the bottom cover 42 to make it invisible. Tags of this type are generally small enough to fit within the back cover of the check presenter and still offer the guests an adequate target touch point.

A logo/marking 46 indicating a wireless payment capability such as the NFC logo, a registered trademark of NFC Forum, Inc., is printed on top of the bottom cover 42. The logo serves to alert the guests as to the existence of the wireless payment services capability contained within the check presenter 2 and as to the proper location of the touch point. Although the wireless communication device 44 is shown as being disposed under the logo 46, it can be disposed anywhere in or on the check presenter 2.

A transparent window 48 is provided in the top cover such that when the top cover is folded together with the bottom cover 42, the logo 46 can be seen through the window, highlighting and differentiating the new “touch here with phone” capability contained within. Preferably, the window includes a magnifier (e.g., magnifying lens) which can be used by the guest to enlarge the physical guest check (not shown) which contains all of the line item details of the meal and the total amount due. The window also enlarges the logo 46 when the guest check is removed, which may alert the guest that the check can be paid by the guest's wireless mobile device.

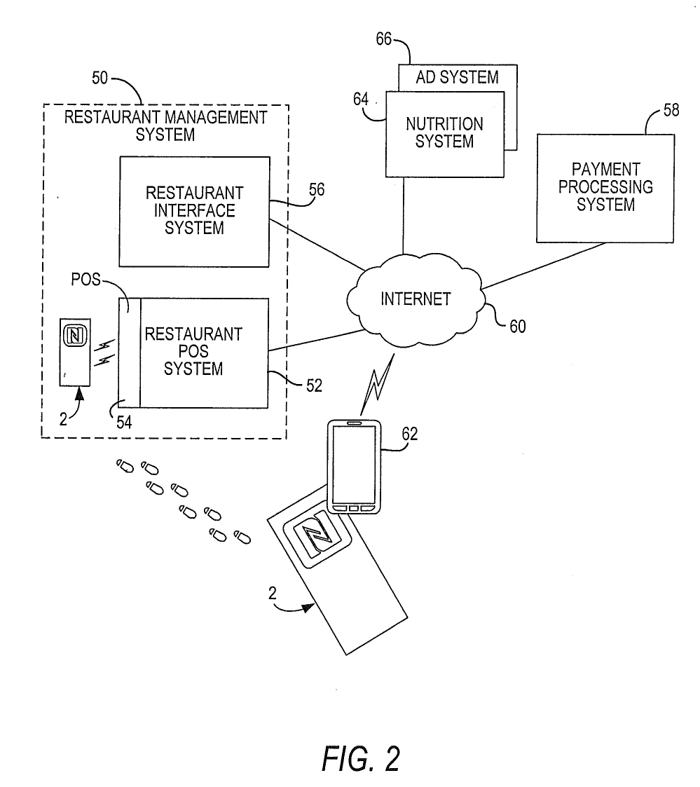

FIG. 2 illustrates an exemplary system for using the present guest check presenter as a platform for offering various mobile services that are associated with the food establishment or the meal consumed by the guest. A restaurant POS system 52 (typically located at the location of the food esstablishment), restaurant interface system 56 and payment processing system 58 are connected to a public communication network 60 such as the Internet. The restaurant POS system 52 runs a restaurant management module which manages orders for a plurality of tables in the restaurant and also manages payments for guest checks. The restaurant POS system 52 includes a POS (point of sale) device 54 for receiving payment information from a credit or debit card. The POS device 54 includes a contactless reader/writer that can communicate with the wireless communication device 44 to write to and read from the wireless communication device as will be explained in detail later herein.

The restaurant interface system 56 runs a restaurant interface module which is adapted to facilitate payments of guest checks which are initiated by the restaurant POS system 52 or by a wireless mobile device 62 of the guest. The wireless mobile device 62 is typically a smart phone device which is capable of accessing the public computer network 60 to communicate with systems that are also connected to the network. The wireless mobile device 62 can be any mobile device that can be carried by the guest such as a PDA (personal digital assistant), cellular telephone device, portable computer, tablet device or the like so long as it can communicate with the network 60 and the wireless communication device 44.

In one embodiment, the restaurant POS system 52 and restaurant interface system 56 comprise a single system (restaurant management system 50) managed by a single entity. In another embodiment, the restaurant interface system 50 is a separate system adapted to interface with a plurality of restaurant POS systems 52 to manage guest check payments by wireless mobile devices 62 for a plurality of different restaurant entities. For example, the restaurant interface system 50 can interface with multiple restaurant entities such as Applebee's restaurant entity of Lenexa, Kans. and Sizzler restaurant entity of Culver City, Calif. to provide mobile payment services for multiple entities.

The payment processing system 58 such as that of First Data Corporation processes all forms of payments for a plurality of merchants including a plurality of restaurants. For example, when the payment processing system 58 receives a credit card payment authorization request from the restaurant interface system 56, it routes the request to the merchant's acquiring bank which then forwards the request to the appropriate interchange system such as VISA™ which then routes the request to the issuing bank of the credit card. The process is reversed for a payment authorization. The authorization message from the issuing bank is routed to the interchange system and then to the acquirer which routes it to the payment processing system 58.

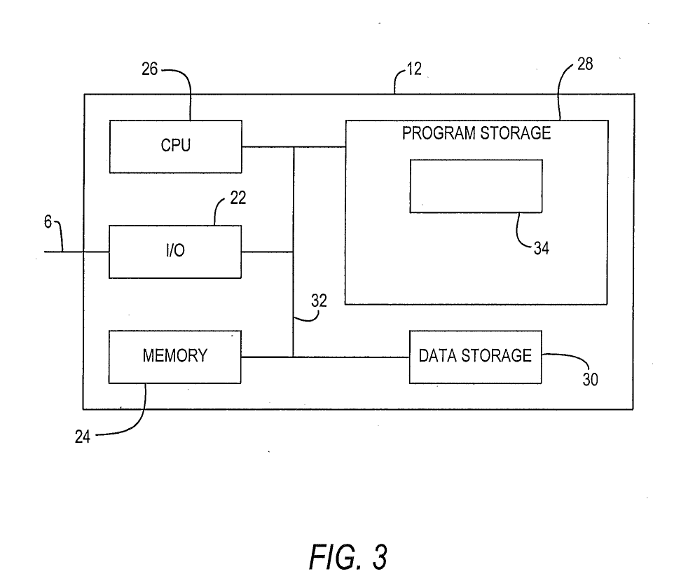

FIG. 3 illustrates an exemplary computer 12 that can be used in any of the computers, servers, databases and wireless devices that are shown in the drawings. For example, the computer 12 can be used in the restaurant POS system 52, restaurant interface system 56, ad system 66, nutrition system 64, wireless communication device 44, wireless mobile device 62 and the payment processing system 58. The computer 12 includes a multitasking, real-time software technology such as the Windows operating system from Microsoft Corporation that can concurrently run multiple applications/modules. The computer 12 is connected to the communication link 6 through an I/O interface 22, which receives information from and sends information over the communication link 6 to other computers in the network 60. The computer 12 includes memory storage 24, processor (CPU) 26, program storage 28, and data storage 30, all commonly connected to each other through a bus 32.

The program storage 28 stores, among others, various software modules such as module 34. For example, the module can be a restaurant management module for the restaurant POS system 52, a restaurant interface module for the restaurant interface system 56 and a restaurant application module for the wireless mobile device 62. The various modules in the program storage 28 and data from the data storage 30 are transferred to the memory 24 as needed and are executed by the CPU 26.

The computer 12 can be any computer such as a personal computer, minicomputer, workstation or mainframe, or a combination thereof. While the computer 12 is shown, for illustration purposes, as a single computer unit, it may comprise a group/farm of computers which can be scaled depending on the processing load and database size.

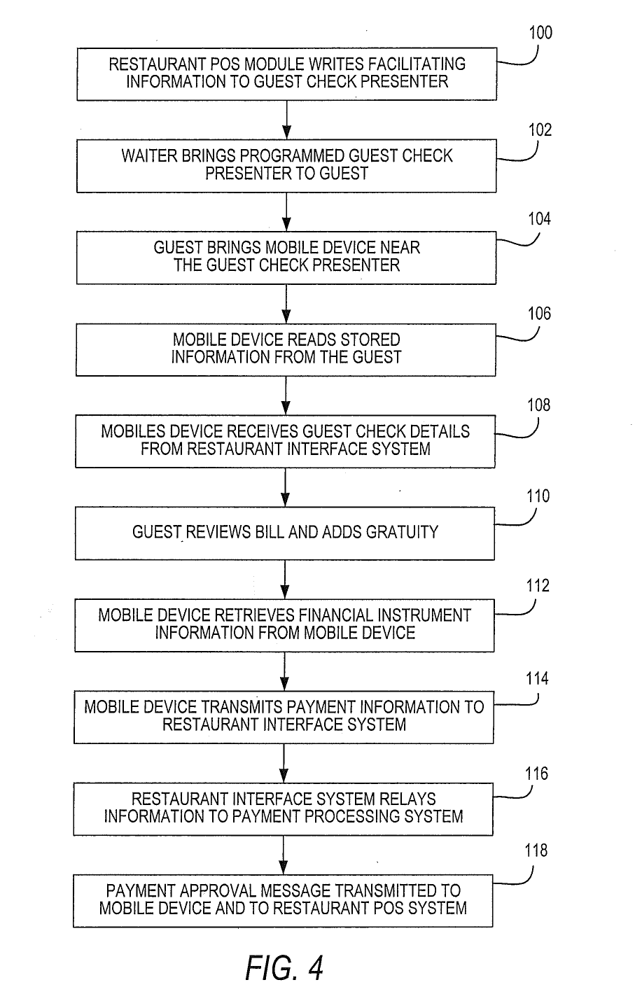

FIG. 4 illustrates a mobile payment service as one of the mobile services that can be offered through the use of the wireless communication device 44 in the check presenter 2. Specifically, FIG. 4 is a process flow diagram of interactions among the various computers and wireless devices to pay for the guest check with the wireless mobile device of the guest. Upon instruction by the waiter, the restaurant management module running in the restaurant POS system 52 displays the guest check for the correct table where the guest is sitting. In step 100, when the waiter brings a check presenter near the wireless reader/writer 54, the restaurant management module writes several payment facilitating information to the memory of the wireless communication device 44 attached to the check presenter 2 through the wireless reader/writer 54. In one embodiment, the payment facilitating information includes the following information: 1) restaurant identifier, 2) unique identifier of the wireless communication device 44, if not present already, 3) identifier of the table where the guest is sitting, 4) identifier of the guest check, 5) location information of the restaurant interface system 56 such as the URL (Uniform Resource Locator) and 6) identifier of a restaurant application which is to be run by the wireless mobile device 62 of the guest when the device is brought near the wireless communication device 44.

At the same time, the restaurant management module also reads the unique identifier of the wireless communication device 44 to associate the particular table and guest check to the wireless communication device. It is important to note that while at least six data items are written to the memory of the wireless communication device 44, the present invention can work with less information. For example, the payment facilitating information can simply include only a guest check identifier that can uniquely identify the guest check. The guest check identifier can be a number that uniquely identifies the guest check or the unique identifier of the wireless communication device 44 since that identifier has been associated with the guest check by the restaurant POS system 52 at step 100. The payment facilitating information can include a single identifier that can associate the wireless communication device 44 to the table or the guest check.

In step 102 the waiter brings the programmed guest check presenter 2 to the guest. The guest check presenter 2 typically includes guest check information such as a physical printout of the check because at this point the waiter has no way of knowing how the guest intends to complete the transaction. Even the customers/guests themselves may wait to see the amount of the check before deciding to pay cash, debit or credit. The benefit of the present invention is that all customers are given their most suitable choice without breaking any accepted norms and without interrupting the routine workflow of the busy wait staff.

In step 104, the guest recognizes the logo 46, highlighted by the magnifying window 48, as indicating a wireless payment capability and brings his wireless mobile device 62 near the logo. In step 106, the wireless mobile device 62 establishes communication with the wireless communication device 44 and reads the stored payment facilitating information.

Based on the restaurant application identifier, the wireless mobile device 62 attempts to locate the application in its data storage. If it does not find the application, the wireless mobile device 62 will attempt to download it through the restaurant interface system 56 using the URL provided by the wireless communication device 44. If the wireless mobile device 62 does locate the application within the device itself, it will load and execute the program. Thus, any subsequent steps done by the wireless mobile device 62 are under the control of the restaurant application.

In step 108, the restaurant application running in the wireless mobile device 62 establishes communication with the restaurant interface system 56 using the provided URL and the wireless mobile device receives line item details of the guest check from the restaurant interface system 56 through the network 60. The restaurant interface system 56 knows which guest check information to send to the wireless mobile device 62 because it has received the unique identifier of the wireless communication device 44 from the wireless mobile device 62 and that identifier had already been associated with the guest check in the restaurant POS system 52 from step 100.

Alternatively, the line item details of the guest check can be programmed into the data storage of the wireless communication device 44 in step 100 in which case such data will be read by the wireless mobile device 62 in step 106.

In step 110, the guest reviews the guest check information either on the wireless mobile device 62 or the physical check and adds any gratuity to the total. In step 112, upon selection of a financial instrument to use for payment by the guest, the wireless mobile device 62 retrieves the selected financial instrument information from a secure memory area of the mobile device. The financial instrument information can include an account number, name of the account holder, expiration date and CVV (card verification value) and the like.

In step 114, upon approval by the guest, the wireless mobile device 62 transmits the payment facilitating information, the retrieved financial instrument information and the total amount including the gratuity to the restaurant interface system 56 for processing the payment. In step 116, the restaurant interface system 56 relays the received information to the payment processing system 58 for payment authorization. The payment processing system 58 processes the payment authorization in a known manner and returns an approval message to the restaurant interface system 56. In step 118, the payment processing system 58 transmits the received approval message to the wireless mobile device 62 as receipt and to the restaurant POS system 52 to indicate to the restaurant management software that the guest check has been paid.

Alternatively, the wireless mobile device 62 can transmit the payment facilitating information, the retrieved financial instrument information and the total amount directly to the payment processing system 58 for processing the payment.

As can be appreciated, the present invention as illustrated in FIG. 4 above offers a very convenient and efficient way for the guest to pay for the guest check without ever having to leave the table and without having to wait for the waiter to pick up the guest check presenter and process the payment.

Another benefit for the guest is that payment using a mobile device is much more secure than payment using a credit card since no physical card has to leave the table. Since the actual work of processing the payment has been offloaded to the guest, the food establishment also benefits since the waiter's time is freed up to perform other tasks.

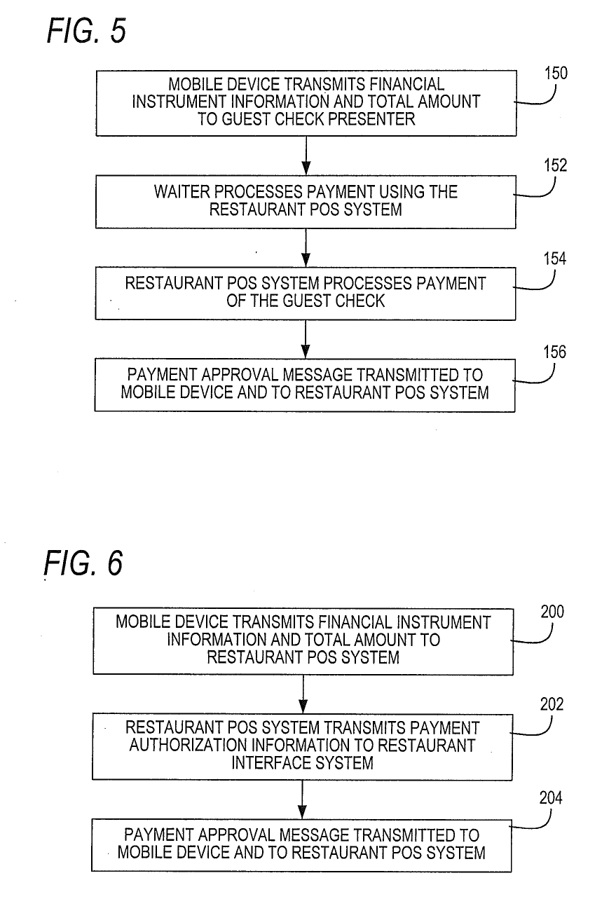

FIG. 5 is an alternate process flow diagram of interactions among the various computers and wireless devices to pay for the guest check with the wireless mobile device of the guest. Steps 100-112 are the same as FIG. 4 and are not shown. Unlike FIG. 4, however, in FIG. 5 the wireless mobile device 62 transmits the financial instrument information to the wireless communication device 44 of the check presenter 2 to pay for the guest check.

After steps 100-112 have been performed, the restaurant application running in the mobile device 62 transmits the retrieved financial instrument information and the total amount including the gratuity to the restaurant interface system 56 for processing the payment (step 150). To prevent an inadvertent payment, the information is transmitted only when the guest brings the mobile device near the guest check presenter such as would be the case if the wireless communication device 44 is an NFC tag device.

In step 152, the waiter picks up the guest check presenter and brings it near the wireless reader/writer 54 to load the guest's financial information and total amount from the wireless communication device 44 to the restaurant POS system 52. In step 154, the restaurant POS system 52 transmits payment authorization information either directly to the payment processing system 58 or to the restaurant interface system 56 which relays the information to the payment processing system 58.

Still in another alternative embodiment, the wireless communication device 44 is capable of communicating directly with the restaurant POS system 52 so that the payment can be processed without involving the waiter again. For example, the wireless communication device 44 can be equipped with a blue tooth type circuit or a WiFi (Wireless Fidelity) Internet device so that the financial instrument information and the total amount stored in the wireless communication device 44 can be transmitted directly to the restaurant POS system 52 for further processing.

In step 156, once the payment has been approved by the payment processing system 58, the restaurant POS system 52 transmits the approval message to the wireless mobile device 62 as receipt.

FIG. 6 is another alternate process flow diagram of interactions among the various computers and wireless devices to pay for the guest check with the wireless mobile device of the guest. Steps 100-112 are the same as FIG. 4 and are not shown. Unlike FIG. 4, however, in FIG. 6 the wireless mobile device 62 communicates with the restaurant POS system 52 to pay for the guest check. Once the restaurant POS system 52 receives the financial instrument information and the total amount, it can process the payment in a conventional manner, for example, as if a credit card was swiped through the POS device 54.

After steps 100-112 have been performed, the restaurant application running in the mobile device 62 transmits the retrieved financial instrument information and the total amount including the gratuity to the restaurant POS system 56 for processing the payment (step 200). In one implementation, the address/URL of the restaurant POS system 56 is included as part of the payment facilitating information so that the wireless mobile device 62 knows how to access the POS system. In step 202, the restaurant POS system 52 transmits payment authorization information either directly to the payment processing system 58 or to the restaurant interface system 56 which relays the information to the payment processing system 58.

In step 204, once the payment has been approved by the payment processing system 58, the restaurant POS system 52 transmits the approval message to the wireless mobile device 62 as receipt.

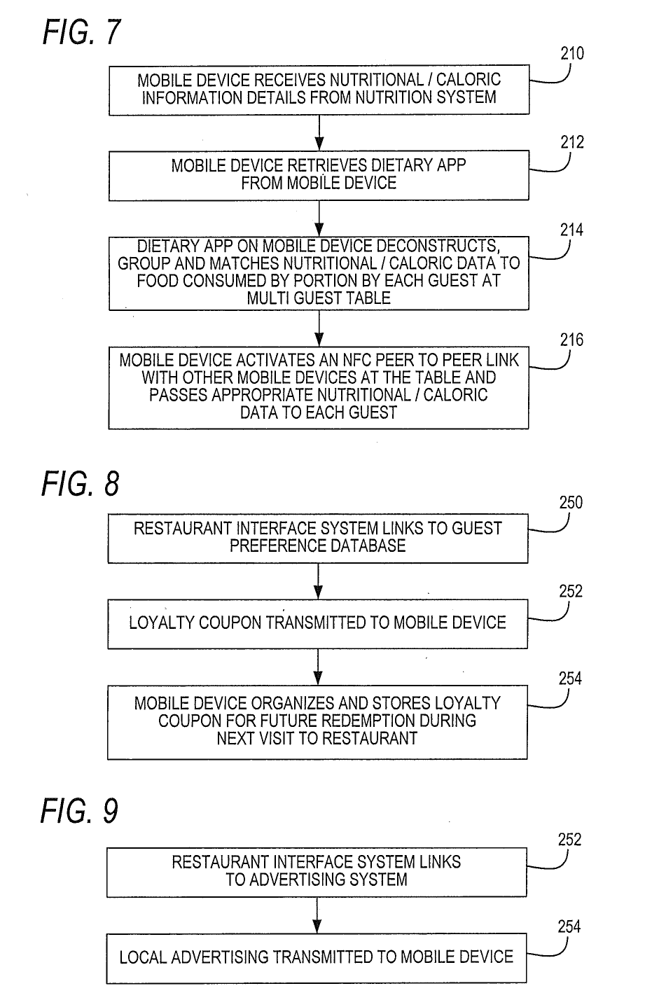

FIG. 7 is a process flow diagram of interactions among the various computers and wireless devices to collect and deliver the nutritional and caloric data from the meal just consumed to the wireless mobile device 62 of the guest. Prior to step 210, steps 100-106 of FIG. 4 are performed. Steps 108-118 can also be performed if the guest chooses to pay for the guest check using the mobile device 62.

In FIG. 7, the wireless mobile device 62 receives nutritional and caloric information details from the nutrition system 64 in step 200. The system 64 can identify the meal consumed by the guest through receipt of the guest check identifier from either the restaurant management system 50 or the mobile device 62. The system 64 then retrieves the nutrition information from the nutrition database (not shown).

In step 212, the mobile device 62 retrieves a dietary application from the nutrition system 64 to be executed in the mobile device. The dietary application can be a separate application which is downloaded or a part of the mobile application as discussed in FIG. 5. In step 214 the nutritional and caloric data is displayed according to the portion of the meal just consumed. The guest using the dietary application running the mobile device 62 is able to freely drag and drop line items to regroup portions if they do not accurately reflect the food/drink consumed by the guest. Also in the case of a group table consisting of more than one guest and reflected in step 216 a NFC peer to peer link will allow one guest to distribute the appropriate nutritional and caloric data to other guests by staging (selecting) the data and bringing the two mobile devices of the guests together to transfer the appropriate nutritional and caloric data corresponding with the meal consumed by guest #2, by guest #3, and guest #N in a contactless manner.

FIG. 8 is a process flow diagram of interactions among the various computers and wireless devices to deliver loyalty coupon data at the end of the meal to the wireless mobile device 62 of the guest. Such loyalty coupons are designed to reward loyal customer and deliver incentives to accelerate the rate of repeat restaurant business. Coupons are also useful to accelerate the consumption of perishable foods and featured specials commonly found in restaurants. Like FIG. 7, steps 100-106 are executed prior to step 250 and are not shown.

In FIG. 8, the restaurant management system 50 links to a guest preference and purchase history database in step 250 in preparation for matching the guest with the most effective incentive for repeat business. In step 252 a loyalty coupon based on either the guest preference or the purchase history or both is transmitted to the mobile device 62. In step 254 the mobile device 62 organizes and stores the loyalty coupon for future use. Mobile coupons are preferred over traditional printed coupons, which are often misplaced by busy people.

FIG. 9 is a process flow diagram of interactions among the various computers and wireless devices to deliver local advertising to the wireless mobile device of the guest. Like FIG. 8, steps 100-106 are executed prior to step 270 and are not shown.

In FIG. 9, the restaurant management system 50 links to the guest preference and purchase history database in step 270 in preparation for matching the guest with the best contextually relevant advertising based on a variety of factors including past dining history, location of restaurant, season, weather, time of day, guest's residence and the like. In step 270 the restaurant management system 50 links to the advertising system 66 and instructs the system 66 to transmit the selected advertising to the mobile device 62. In step 272 the selected local advertising is transmitted to the mobile device 62 by the system 66.

There are many more mobile services that are possible with the present invention. For example, the wireless mobile device 62. through its mobile application, can transmit a request to the restaurant POS system 52 to alert a valet parking attendant to retrieve the guest's car. The request presumably contains a ticket identifier that identifies the guest's car. As another example, the wireless mobile device 62. through its mobile application, can transmit a request (containing a coat identifier) to the restaurant POS system 52 to alert a coat check attendant to retrieve the guest's coat.

The foregoing specific embodiments represent just some of the ways of practicing the present invention. Many other embodiments are possible within the spirit of the invention. For example, the ad system 66 and nutrition system 64 can be a part of the restaurant management system 50 and more specifically the restaurant interface system 56. Accordingly, the scope of the invention is not limited to the foregoing specification, but instead is given by the appended claims along with their full range of equivalents.

What is claimed is:

1. A guest check presenter for a food establishment comprising:
a holder for holding a physical guest check; and
a wireless communication device attached to the holder and adapted to communicate with a wireless mobile device of the guest, the wireless communication device storing a guest check identifier for retrieval by the wireless mobile device of the guest for use in facilitating mobile services associated with the food establishment or the food consumed by the guest.

2. The guest check presenter of claim 1, wherein the wireless communication device includes a near-field communications (NFC) chip.

3. The guest check presenter of claim 1, wherein the wireless communication device is adapted to transmit the guest check identifier to the wireless mobile device of the guest when the wireless mobile device is brought near the wireless communication device.

4. The guest check presenter of claim 1, wherein the wireless communication device stores information identifying the table of the guest.

5. The guest check presenter of claim 1, wherein the guest check identifier identifies the wireless communication device which is associated with the guest check.

6. The guest check presenter of claim 1, wherein the wireless communication device stores a location identifier of a restaurant management system which can be accessed by the wireless mobile device through a public communication network.

7. The guest check presenter of claim 1, further comprising a restaurant interface module running in a restaurant management system and adapted to transmit line item details of the guest check to the wireless mobile device for display.

8. The guest check presenter of claim 1, further comprising a restaurant interface module running in a restaurant management system and adapted to:
receive information of a financial instrument belonging to the guest from the wireless mobile device; and
transmit the received financial instrument information to a payment processing system to initiate the process of payment for the guest check.

9. The guest check presenter of claim 1, further comprising a restaurant POS system located at the food establishment and adapted to associate the guest check to the wireless communication device attached to the holder.

10. The guest check presenter of claim 9, wherein the restaurant POS system includes a wireless reader/writer adapted to write the guest check identifier to the wireless communication device in a wireless manner.

11. The guest check presenter of claim 1, further comprising a restaurant interface module running in a restaurant management system and adapted to transmit a loyalty coupon to the wireless mobile device of the guest.

12. The guest check presenter of claim 1, further comprising a restaurant interface module running in a restaurant management system and adapted to transmit a targeted advertising information to the wireless mobile device of the guest.

13. A guest check presenter for a establishment comprising:
a holder for holding a guest check information; and
a wireless communication device attached to the holder and adapted to communicate with a wireless mobile device of a guest, the wireless communication device containing payment facilitating information for facilitating a payment for the guest check by the wireless mobile device of the guest.

14. The guest check presenter of claim 13, wherein the wireless communication device is adapted to uniquely identify the guest in the food establishment.

15. The guest check presenter of claim 13, wherein the wireless communication device is adapted to associate the guest to the guest check.

16. The guest check presenter of claim 13, wherein the wireless communication device includes a near-field communications (NFC) chip.

17. The guest check presenter of claim 16, wherein the wireless communication device is adapted to transmit the payment facilitating information to the wireless mobile device of the guest when the wireless mobile device is brought near the wireless communication device.

18. The guest check presenter of claim 13, wherein the payment facilitating information includes information identifying the table of the guest.

19. The guest check presenter of claim 13, wherein the payment facilitating information includes information identifying the wireless communication device attached to the holder.

20. The guest check presenter of claim 13, wherein the payment facilitating information includes a location identifier of a restaurant management system which can be accessed by the wireless mobile device through a public communication network.

21. The guest check presenter of claim 20, wherein the location identifier includes an Internet address by which the restaurant management system can be accessed by the wireless mobile device.

22. The guest check presenter of claim 13, further comprising a restaurant interface module running in a restaurant management system and adapted to transmit line item details of the guest check to the wireless mobile device for display.

23. The guest check presenter of claim 13, further comprising a restaurant interface module running in a restaurant management system and adapted to:
receive information of a financial instrument belonging to the guest from the wireless mobile device; and
transmit the received financial instrument information to a payment processing system to initiate the process of payment for the guest check.

24. The guest check presenter of claim 13, further comprising a restaurant management system adapted to interface with a plurality of restaurant POS systems to manage guest check payments by wireless mobile devices for a plurality of restaurant entities.

25. The guest check presenter of claim 13, further comprising a restaurant POS system located at a restaurant and adapted to associate the guest check to the wireless communication device attached to the holder.

26. The guest check presenter of claim 25, wherein the restaurant POS system includes a wireless reader/writer adapted to write the payment facilitating information to the wireless communication device in a wireless manner.

27. The guest check presenter of claim 13, further comprising a restaurant interface module running in a restaurant management system and adapted to transmit a loyalty coupon to the wireless mobile device of the guest.

28. The guest check presenter of claim 13, further comprising a restaurant interface module running in a restaurant management system and adapted to transmit a targeted advertising information to the wireless mobile device of the guest.

29. The guest check presenter of claim 13, further comprising a restaurant application module running in the wireless mobile device of the guest and adapted to retrieve information of a financial instrument of the guest, and transmit the received payment facilitating information and the retrieved financial instrument information to a restaurant management system residing on a public communication network.

30. The guest check presenter of claim 13, further comprising a restaurant application module running in the wireless mobile device of the guest and adapted to interact with the guest to allow review of the guest check and add a gratuity amount to the guest check prior to payment.

31. The guest check presenter of claim 13, wherein the holder includes a logo indicating a wireless payment capability and a window through which the logo is viewable.

32. A guest check presenter for a food establishment comprising:
a holder for holding a restaurant guest check information, the holder having
a window; and
a logo indicating a wireless payment capability and disposed to be viewable by a guest; and
a wireless communication device attached to the holder and adapted to communicate with a wireless mobile device of the guest, the wireless communication device containing payment facilitating information for facilitating a payment for the restaurant guest check by the wireless mobile device of the guest.

33. A method for providing mobile services to guests at a food establishment comprising:
providing a guest check presenter including a holder for holding a restaurant guest check information and a wireless communication device attached to the holder and adapted to communicate with a wireless mobile device of the guest;
receiving, for storage in the wireless communication device, a guest check identifier that identifies the guest check from a restaurant management system;
transmitting, to the wireless mobile device of the guest, the stored guest check identifier for facilitating mobile services associated with the food establishment or the food consumed by the guest.

34. The method of claim 33, wherein:
the wireless communication device includes a near-field communications (NFC) chip; and
the step of receiving includes storing the guest check identifier in the NFC chip.

35. The method of claim 33, further comprising transmitting, by the wireless communication device, the stored guest check identifier to the wireless mobile device of the guest when the wireless mobile device is brought near the wireless communication device.

36. The method of claim 33, wherein the step of receiving includes receiving information identifying the table of the guest.

37. The method of claim 33, wherein the step of receiving includes receiving information identifying the wireless communication device.

38. The method of claim 33, wherein the step of receiving includes receiving a location identifier of a restaurant management system which can be accessed by the wireless mobile device through a public communication network.

39. The method of claim 33, further comprising transmitting, by a restaurant management system, line item details of the guest check to the wireless mobile device for display.

40. The method of claim 33, further comprising:
under the control of a restaurant management system,
receiving information of a financial instrument belonging to the guest from the wireless mobile device; and
transmitting the received financial instrument information to a payment processing system to initiate the process of payment for the guest check.

41. The method of claim 33, further comprising associating, by a restaurant POS system, the guest check to the wireless communication device attached to the holder.

42. The method of claim 33, further comprising writing the guest check identifier to the wireless communication device in a wireless manner by a restaurant POS system.

43. The method of claim 33, further comprising:
under the control of a restaurant management system,
transmitting a loyalty coupon or targeted advertising information to the wireless mobile device of the guest.

44. A method for a guest to pay for a guest check at a food establishment comprising:
providing a guest check presenter including a holder for holding a restaurant guest check information and a wireless communication device attached to the holder and adapted to communicate with a wireless mobile device of the guest;
receiving, for storage in the wireless communication device, payment facilitating information from a restaurant management system;
transmitting, to the wireless mobile device of the guest, the stored payment facilitating information for facilitating a payment for the guest check by the wireless mobile device of the guest.

45. The method of claim 44, wherein the step of receiving includes receiving the payment facilitating information which is sufficient to uniquely identify the guest in the food establishment.

46. The method of claim 44, wherein the step of receiving includes receiving the payment facilitating information which associates the guest to the guest check.

47. The method of claim 44, wherein:
the wireless communication device includes a near-field communications (NFC) chip; and
the step of receiving includes storing the payment facilitating information for storage in NFC chip.

48. The method of claim 44, further comprising transmitting, by the wireless communication device, the stored payment facilitating information to the wireless mobile device of the guest when the wireless mobile device is brought near the wireless communication device.

49. The method of claim 44, wherein the step of receiving includes receiving information identifying the table of the guest.

50. The method of claim 44, wherein the step of receiving includes receiving information identifying the wireless communication device.

51. The method of claim 44, wherein the step of receiving includes receiving a location identifier of a restaurant management system which can be accessed by the wireless mobile device through a public communication network.

52. The method of claim 51, wherein the step of receiving the location identifier includes receiving an Internet address by which the restaurant management system can be accessed by the wireless mobile device.

53. The method of claim 44, further comprising transmitting, by a restaurant management system, line item details of the guest check to the wireless mobile device for display.

54. The method of claim 44, further comprising:
under the control of a restaurant management system,
receiving information of a financial instrument belonging to the guest from the wireless mobile device; and
transmitting the received financial instrument information to a payment processing system to initiate the process of payment for the guest check.

55. The method of claim 44, further comprising associating, by a restaurant POS system, the guest check to the wireless communication device attached to the holder.

56. The method of claim 44, further comprising:
under the control of a restaurant management system,
transmitting a loyalty coupon or targeted advertising information to the wireless mobile device of the guest.
